(19) United States
(12) Patent Application Publication
(10) Pub. No.: US 2012/0274163 A1
(43) Pub. Date: Nov. 1, 2012

(54) POWER UNIT

(75) Inventors: Shinichi Matsumoto, Toyota-shi (JP); Keiji Takizawa, Toyota-shi (JP); Hiroshi Hoshina, Toyota-shi (JP); Yasuhiro Yamaguchi, Toyota-shi (JP); Masaaki Takemoto, Toyokawa-shi (JP)

(73) Assignee: TOYOTA JIDOSHA KABUSHIKI KAISHA, Toyota-shi (JP)

(21) Appl. No.: 13/455,636

(22) Filed: Apr. 25, 2012

(30) Foreign Application Priority Data
Apr. 27, 2011 (JP) 2011-099070

(51) Int. Cl. H02K 11/00

(52) U.S. Cl. 310/71

(57) ABSTRACT

A power unit includes a case, a first rotary electric machine arranged inside the case, a second rotary electric machine that is arranged parallel to the first rotary electric machine and that is arranged inside the case, a plurality of conductors that send electric power to the first rotary electric machine and the second rotary electric machine, and that receive electric power from the first rotary electric machine and the second rotary electric machine, and a cover member that covers a single opening provided in the case and communicating an inside of the case with an outside of the case, the plurality of conductors passing through the cover member. A valley shape is formed by an outer peripheral surface of the first rotary electric machine and an outer peripheral surface of the second rotary electric machine. The opening is provided in a portion of the case that faces the valley shape.

### INCORPORATION BY REFERENCE

The disclosure of Japanese Patent Application No. 2011-099070 filed on Apr. 27, 2011 including the specification, drawings and abstract is incorporated herein by reference in its entirety.

### BACKGROUND OF THE INVENTION

1. Field of the Invention

The invention relates to power unit in which a rotary electric machine is provided in a case.

2. Description of Related Art

A power unit in which a rotary electric machine is housed in a case is known. The rotary electric machine functions as an electric motor that generates power for driving a vehicle, and also functions as a generator that converts kinetic energy of the vehicle into electric energy when braking. In the description below, a prime mover that is able to function as at least one of an electric motor and a generator will be described as the rotary electric machine. A power unit for a hybrid vehicle in which a rotary electric machine is integrated with a transaxle or a transmission attached to an internal combustion engine is in practical use In this power unit, the rotary electric machine is housed in a case of the transaxle or the like.

To supply electric power to the rotary electric machine housed in the case, or to deliver electric power generated by the rotary electric machine outside the case, a conductor that communicates the inside of the case with the outside of the case must be arranged through an opening made in a portion of the case. The opening is covered and blocked off by a cover member, and the cover member is configured to allow the conductor to communicate the inside of the case with the outside of the case.

Japanese Patent Application Publication No 2008-230531 (JP 2008-230531 A) describes a power unit for a hybrid vehicle that includes two rotary electric machines.

It is preferable that the number of the opening formed in the case that houses the rotary electric machine be low. It is also preferable that the structure of the cover member for covering the opening be simple. When the rotary electric machine is housed in the case of a transaxle or the like, as described above, it is necessary to ensure that lubricating oil or the like inside the transaxle does not leak out from the cover portion, and it is preferable that the structure for achieving this also be simple.

### SUMMARY OF THE INVENTION

The invention provides a power unit that reduces the number of the opening in a case and/or simplifies the structure of a cover member that covers the opening.

A first aspect of the invention relates to a power unit. This power unit includes a case, a first rotary electric machine arranged inside the case, a second rotary electric machine that is arranged parallel to the first rotary electric machine and that is arranged inside the case, a plurality of conductors that send electric power to the first rotary electric machine and the second rotary electric machine, and that receive electric power from the first rotary electric machine and the second rotary electric machine, and a cover member that covers a single opening provided in the case and communicating an inside of the case with an outside of the case, the plurality of conductors passing through the cover member. A valley shape is formed by an outer peripheral surface of the first rotary electric machine and an outer peripheral surface of the second rotary electric machine. The opening is provided in a portion of the case that faces the valley shape. With this power unit, a single opening is made in the case to supply electric power to two rotary electric machines, so the number of openings is reduced. When the two rotary electric machines are arranged in parallel, the outer peripheral surfaces of the rotary electric machines form a valley shape. A single opening through which conductors for sending and receiving electric power is provided in a portion of the case that faces this valley shape. A cover member that covers this opening is provided, and conductors are arranged in the cover member, so as to pass through the cover member. Electric power is sent and received to and from the two rotary electric machines in the case via these conductors. Sharing the opening and cover member among the two rotary electric machines enables the number of openings provided in the case to be reduced.

In this power unit, the conductors may be electric power lines that extend from outside of the case to a terminal of a power line of the first rotary electric machine or a terminal of a power line of the second rotary electric machine.

In this power unit, each of the electric power lines may include a core wire and a covering that covers the core wire, each of the electric power lines may have a removed portion where the covering has been removed, and the removed portion and a portion adjacent to the removed portion may be embedded in the cover member.

In this power unit, the removed portions of the electric power lines that are adjacent may be arranged offset from each other in a direction in which the electric power lines extend.

In this power unit, the removed portions of the electric power lines that are adjacent may be arranged so as not to overlap with each other in the direction in which the electric power lines extend.

According to this aspect of the invention, the number of the opening can be made lower, or the structure of the cover that covers the opening can be simplified.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a simplified view of the internal structure of a transaxle according to an example embodiment of the invention;

FIG. 2 is a detailed view of electric power lines and a cover member through which these electric power lines pass, according to the example embodiment of the invention;

FIG. 3 is a sectional view taken along line A-A in FIG. 2;

FIG. 4 is a sectional view of the cover member according to the example embodiment of the invention;

FIG. 5 is a more detailed sectional view of the cover member according to the example embodiment of the invention; and

FIG. 6 is a view of an example in which a bus bar is used instead of the electric power lines, according to the example embodiment of the invention.

### DETAILED DESCRIPTION OF EMBODIMENTS

Hereinafter, example embodiments of the invention will be described with reference to the accompanying drawings. As an example embodiment of the invention, an example in which a power unit with an internal combustion engine and two rotary electric machines provided as the prime mover will be described. An internal combustion engine such as an Otto engine or a diesel engine may be used together with a transmission, and also may be used together with a transaxle in which a transmission is integrated with a differential gear unit. In this example embodiment, a power unit using a transaxle will be described as an example.

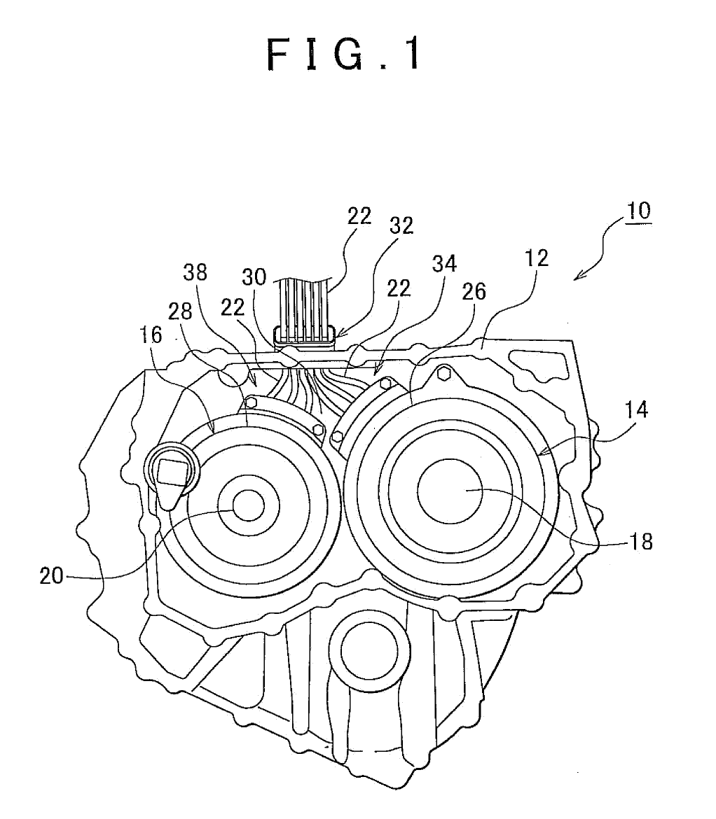

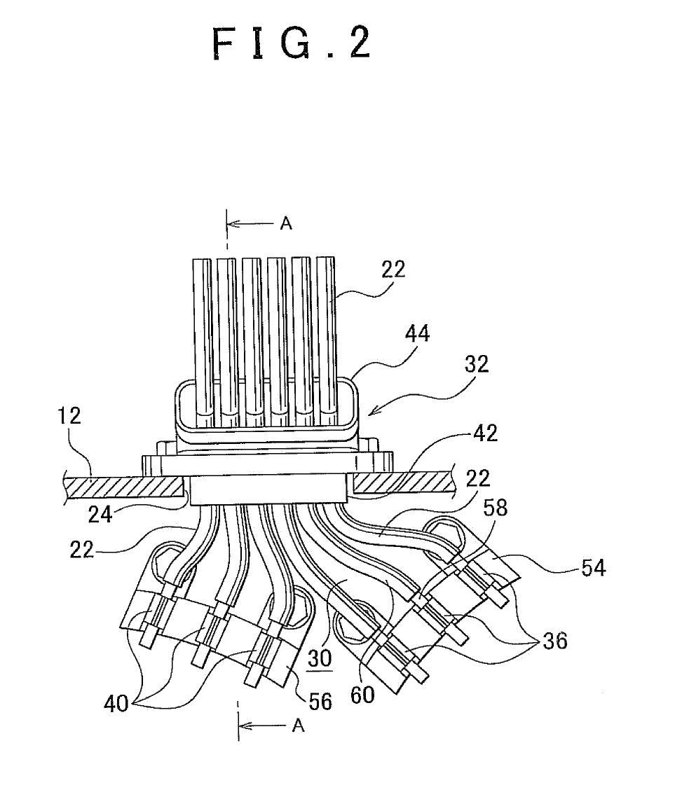

FIG. 1 is a simplified view of the internal structure of a transaxle 10. A first rotary electric machine 14 and a second rotary electric machine 16 are housed inside of a transaxle case (hereinafter, simply referred to as a “case”) 12. A gear change mechanism that includes a planetary gear, for example, is provided on the far side in the drawing (i.e., away, in the depth direction, from the surface of the paper on which FIG. 1 is drawn), and a differential gear unit is housed below in the drawing. The first rotary electric machine 14 and the second rotary electric machine 16 are arranged in parallel, and a shaft 18 of the first rotary electric machine 14 and a shaft 20 of the second rotary electric machine 16 are parallel. Electric power lines 22 are connected to the two rotary electric machines 14 and 16. Three electric power lines 22 are provided for each rotary electric machine, for a total of six electric power lines 22. These electric power lines 22 pass through an opening 24 (see FIG. 2) provided in the case 12, thus communicating the inside of the case with the outside of the case. Three-phase alternating-current (AC) electric power is supplied from an inverter, not shown, to the rotary electric machines via the electric power lines 22. Also, electric power generated by the rotary electric machines is sent to the inverter via the electric power lines 22, and then sent to a secondary battery, also not shown, to charge the secondary battery.

The first rotary electric machine 14 and the second rotary electric machine 16 each have a structure of a typical rotary electric machine having a cylindrical-shaped stator, and a rotor that is able to rotate arranged inside of the stator. The outer peripheral surface of the stator is the outer peripheral surface of the rotary electric machine, and this is a cylindrical columnar side surface. When two cylindrical columns are adjacent with their axes parallel to one another, a generally V-shaped valley is formed between the side surfaces. A generally V-shaped valley portion 30 is formed just above substantially the center in the left-right direction of the inside of the case 12 in FIG. 1 by an outer peripheral surface 26 of the first rotary electric machine 14 and an outer peripheral surface 28 of the second rotary electric machine 16. The opening 24 is provided in a portion of the case 12 that faces the valley portion 30, and a cover member 32 is arranged so as to cover this opening. The electric power lines 22 are arranged passing through this cover member 32. Terminals 36 (see FIG. 2) of power lines that are connected to a coil of the first rotary electric machine 14 are provided on a portion 34 of the outer periphery of the first rotary electric machine 14 that faces the valley portion 30. Also, terminals 40 (see FIG. 2) of power lines that are connected to a coil of the second rotary electric machine 16 are provided on a portion 38 of the outer periphery of the second rotary electric machine 16 that faces the valley portion 30.

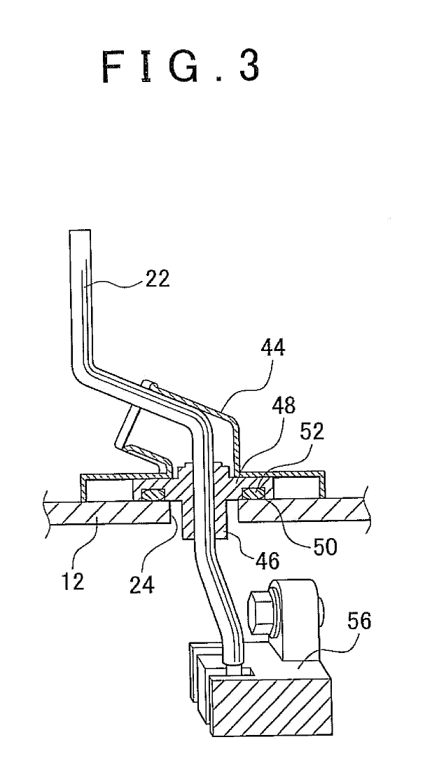

FIGS. 2 and 3 are enlarged views of the structure around the valley portion 30 formed between the two rotary electric machines 14 and 16. FIG. 3 is a sectional view taken along line A-A in FIG. 2. The opening 24 of the case 12 is covered by the cover member 32. The cover member 32 includes a cover main body 42 that actually covers the opening 24, and a shield shell 44 provided to further cover the cover main body 42. The cover main body 42 includes a through-portion 46 arranged through the opening 24, and a flange 48 provided protruding out around the through-portion 46. The cover main body 42 is fixed to the case 12 by the flange 48 being fastened to the case 12 by a bolt or the like. When the cover main body 42 is fixed to the case 12, an annular groove 50 surrounding the opening 24 is provided in the surface of the flange 48 that faces the case 12, and a seal member 52 made of elastic or flexible material, such as rubber, is arranged therein. The area between the cover main body 42 and the case 12 is sealed by the seal member 52, by the cover main body 42 being fixed to the opening 24.

The electric power lines 22 pass through the through-portion 46 and extend inside and outside the case 12. The portions of the electric power lines 22 that extend outside the case 12 are connected to control equipment of the rotary electric machines, such as an inverter. Also, the portions of the electric power lines 22 that extend inside the case 12 are arranged in the valley portion 30 and connected to the terminals 36 and 40 of the power lines of the first and second rotary electric machines 14 and 16. The terminals 36 of the power lines of the first rotary electric machine 14 are retained by a terminal holder 54 and connected to the electric power lines 22 by a method such as welding or crimping (pressure bonding). The terminals 40 of the power lines of the second rotary electric machine 16 are also retained by a terminal holder 56 and connected to the electric power lines 22 by a method such as welding or crimping. The terminal holders 54 and 56 are fixed to the case 12 by fastening elements such as bolts, for example.

The shield shell 44 is able to cover the flange 48, and be fastened together with the flange 48 and fixed to the case 12. The shield shell 44 also extends above (upward in FIG. 3) the through-portion 46 of the cover main body 42, and is then bent as shown in FIG. 3. This portion is conduit-shaped or duct-shaped, surrounds the electric power lines 22, and guides the electric power lines 22. Also, the shield shell 44 is made of conductive material, and shields against electromagnetic noise both from the electric power lines 22, and from inside the case 12.

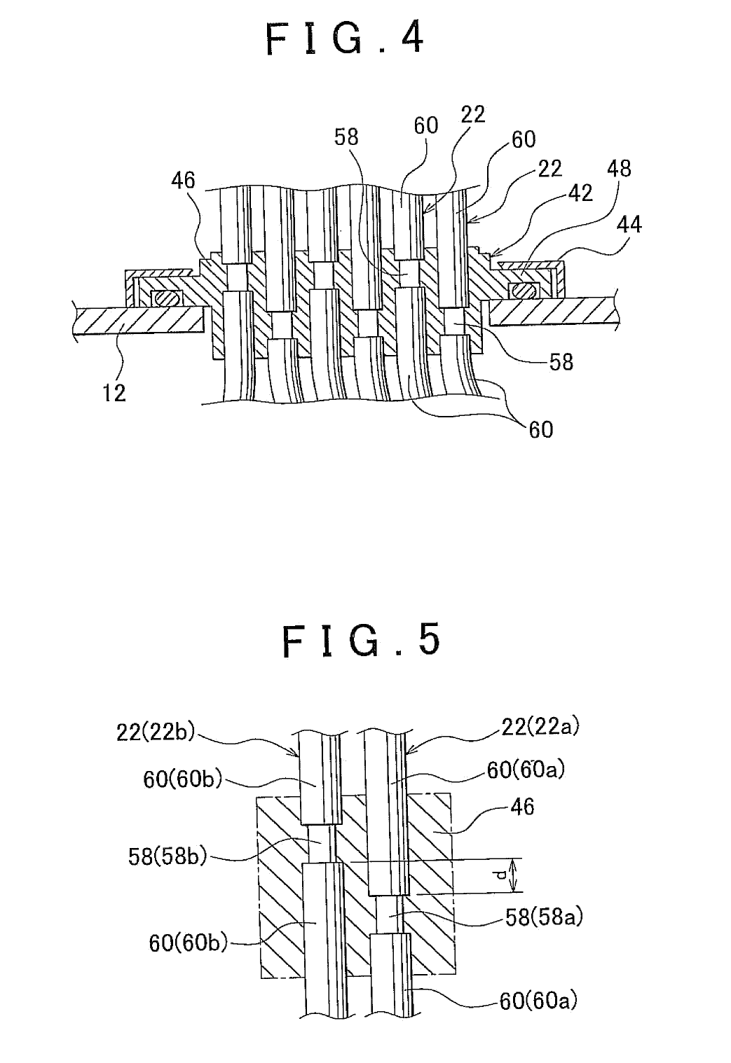

FIG. 4 is a sectional view showing the electric power lines 22 passing through the cover main body 42. Each of the electric power lines 22 is a covered wire in which a core wire 58 that is formed from a rod-shaped conductor is covered by a covering 60, for example. If the electric power lines 22 are arranged passing through the case 12 with the coverings 60 as they are, lubricating oil or the like inside the case may leak out of the case through gaps between the core wires 58 and the coverings 60. As shown in FIG. 2, at the tip ends of the electric power lines 22, the coverings 60 are removed to expose the core wires 58, and the terminals 36 and 40 of the power lines are connected to the exposed core wires 58 by crimping or the like. Lubricating oil enters from the boundary with the core wires 58 at the end of the coverings 60, and flows out of the case 12 through the insides of the electric power lines 22, or more particularly, through gaps between the core wires 58 and the coverings 60.

In order to stop the flow of lubricating oil inside the electric power lines 22, the coverings 60 of the electric power lines 22 are removed to expose the core wires 58 inside the cover main body 42, or more particularly, inside the through-portion 46, and moreover, the portions where the coverings 60 have been removed, as well as portions adjacent to these portion, are embedded in the cover main body 42. More specifically, the cover main body 42 is manufactured by casting, i.e., insert-forming, the portions where the coverings have been removed and the portions adjacent to these portions, when mold forming the cover main body 42. The cover main body 42 is made of insulating resin. The resin of which the cover main body 42 is formed adheres to the exposed core wires 58, and this impedes the flow of lubricating oil.

FIG. 5 is a detailed view of the portion of the through-portion 46 where the electric power lines 22 are embedded. In order to distinguish between two adjacent electric power lines 22, one will be appended with the letter a and the other will be appended with the letter b. This is the same for the core wires 58 and the coverings 60 as well With the electric power line 22a and the electric power line 22b, the positions of the portions where the coverings have been removed are different in the direction in which the electric power lines extend. An exposed core wire 58a, in which the covering has been removed, of the electric power line 22a is positioned close to a lower end of the through-portion 46, and the exposed core wire 58b of the electric power line 22b is positioned close to an upper end of the through-portion 46. With this arrangement, the exposed core wire 58a and the exposed core wire 58b are arranged offset in the direction in which the electric power lines 22 extend, so an insulating distance between the core wires is able to be ensured. An amount d that the positions of the exposed core wire 58a and the exposed core wire 58b are offset is determined taking the insulating distance into account. Although evident from the viewpoint of ensuring the insulating distance, the offset arrangement of the exposed core wire 58a and the exposed core wire 58b is an arrangement in which these portions do not overlap in the direction in which the electric power lines 22 extend. In other words, the dimension d in FIG. 5, i.e., the distance d between the upper end of the exposed core wire 58a that is positioned on the lower end side of the through-portion 46, and the lower end of the exposed core wire 58b that is positioned on the upper end side of the through-portion 46, is such that d will be greater than zero (i.e., d>0).

Conventionally, in order to connect electric power lines inside and outside of a case, a connector is fixed to an opening of the case, and the electric power lines inside and outside of the case are each connected to a conductor that passes through this connector. Using the cover member in this example embodiment enables the structure to be simpler than that of the conventional connector, and also enables the number of man-hours for connecting the electric power lines to be reduced.

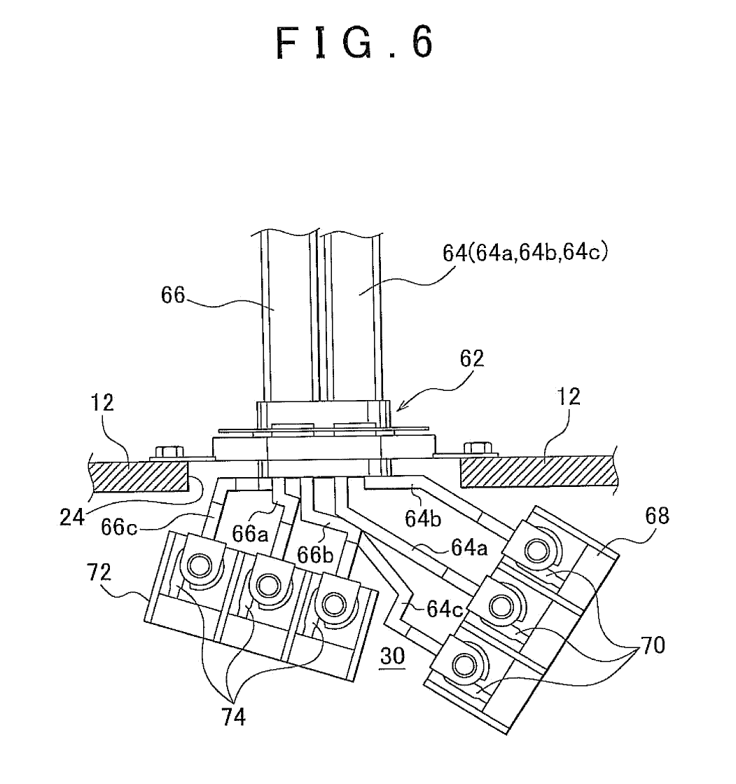

FIG. 6 is a view of an example in which a plate-shaped conductor, a so-called bus bar, is used instead of the electric power lines that are the covered wires described above. The point where the opening 24 that faces the valley portion 30 formed between the two rotary electric machines 14 and 16 is formed in the case 12 is the same as it is in the example embodiment described above. The opening 24 is covered and blocked off by a cover member 62. The cover member 62 is fixed to the case 12 by a fastening element such as a bolt. Bus bars 64 and 66 are provided passing through the cover member 62. Three bus bars 64 are stacked with insulating layers in between, in the direction passing through the paper on which FIG. 6 is drawn, on the outside of the case 12. When distinguishing between the three bus bars 64, they will be appended with the letters a, b, and c starting with the one in front. This is also the same for the bus bars 66 as well. The bus bars 64 and 66 are arranged stacked on the inside of the cover member 62 as well, continuing on from outside of the case 12.

The three bus bars 64a, 64b, and 64c each become thinner inside the case 12. The width of the thin portion is less than ½, and preferably ⅓, the width of the thick portion. Each of the bus bars 64a, 64b, and 64c is arranged inside the valley portion 30, heading toward a terminal holder 68, and connected to a terminal 70 of a power line that is retained there. The tip end of each bus bar 64a, 64b, and 64c is formed in a plate shape with a hole in it. A bolt is inserted into the hole and tightened, such that the terminal 70 of the power line is sandwiched by the tip end of the bus bar and the terminal holder 68. The bus bar 64a that is positioned in front in FIG. 6 and a portion inside the case, of the bus bar 64c that is positioned in back, are arranged against one of the edges in the width direction of the thick portion outside the case (i.e., on the left side in the drawing). The portion inside the case, of the bus bar 64b that is positioned in the middle, is arranged against the other edge (i.e., on the right side in the drawing). As a result, the insulating distances of the bus bar 64b from the bus bars 64a and 64c are ensured. Also, the insulating distance between the bus bars 64a and 64c is ensured by the thickness of the insulating layers that insulate the bus bars from the bus bar 64b that is positioned in between them.

The three bus bars 66a, 66b, and 66c each become thinner inside the case 12. The width of the thin portion is less than ½, and preferably ⅓, the width of the thick portion. Each of the bus bars 66a, 66b, and 66c is arranged inside the valley portion 30, heading toward a terminal holder 72, and connected to a terminal 74 of a power line that is retained there. The tip end of each bus bar 66a, 66b, and 66c is formed in a plate shape with a hole in it. A bolt is inserted into the hole and tightened, such that the terminal 74 of the power line is sandwiched by the tip end of the bus bar and the terminal holder 72. The bus bar 66a that is positioned in front in FIG. 6 and a portion inside the case, of the bus bar 66c that is positioned in back, are arranged against one of the edges in the width direction of the thick portion outside the case (i.e., on the left side in the drawing). The portion inside the case, of the bus bar 66b that is positioned in the middle, is arranged against the other edge (i.e., on the right side in the drawing). As a result, the insulating distances of the bus bar 66b from the bus bars 66a and 66c are ensured. Also, the insulating distance between the bus bars 66a and 66c is ensured by the thickness of the insulating layers that insulate the bus bars from the bus bar 66b that is positioned in between them.

The portions of the bus bars that are in the case are thin and very flexible, so they are easy to position with respect to the terminal holders 68 and 72. Moreover, the thin portions may also be annealed to increase their flexibility.

The invention relates to a cover member that covers an opening in a case, and through which electric power lines pass. The cover members described below are provided. (1) A cover member that covers an opening made in a case to pass electric power lines for supplying electric power to a rotary electric machine arranged inside of the case through. Each of the electric power lines has a core wire and a coating (covering) that covers the core wire, and a portion where the coating has been removed is provided on a portion of each electric power line. The electric power lines pass through the cover member, and the portions of the electric power lines where the coating has been removed, and portions adjacent to these portions, are embedded in the cover member. (2) The cover member described above in (1), in which the portions of the electric power lines where the coating has been removed are arranged offset from each other, in the direction in which the electric power lines extend, among adjacent electric power lines.

The invention relates to electric power lines of covered wires. The seal structures described below are provided. (3) A seal structure that covers an opening provided in a case in which a rotary electric machine is housed. This seal structure has i) electric power lines, each of which includes a core wire and a covering that covers the core wire, as well as a portion where the covering has been removed, and ii) a cover member that covers the opening, and through which the electric power lines pass, and in which the portions where the coverings of the electric power lines have been removed and portions adjacent thereto are cast. (4) The seal structure described in (3), in which the portions where the covering of the electric power lines have been removed are arranged offset from each other, in the direction in which the electric power lines extend, among adjacent electric power lines.

What is claimed is:

1. A power unit comprising:
a case;
a first rotary electric machine arranged inside the case;
a second rotary electric machine that is arranged parallel to the first rotary electric machine and that is arranged inside the case;
a plurality of conductors that send electric power to the first rotary electric machine and the second rotary electric machine, and that receive electric power from the first rotary electric machine and the second rotary electric machine; and
a cover member that covers a single opening provided in the case and communicating an inside of the case with an outside of the case, the plurality of conductors passing through the cover member,
wherein a valley shape is formed by an outer peripheral surface of the first rotary electric machine and an outer peripheral surface of the second rotary electric machine, and
wherein the opening is provided in a portion of the case that faces the valley shape.

2. The power unit according to claim 1, wherein the conductors are electric power lines that extend from outside of the case to a terminal of a power line of the first rotary electric machine or a terminal of a power line of the second rotary electric machine.

3. The power unit according to claim 2, wherein each of the electric power lines includes a core wire and a covering that covers the core wire; each of the electric power lines has a removed portion where the covering has been removed; and the removed portion and a portion adjacent to the removed portion are embedded in the cover member.

4. The power unit according to claim 3, wherein the removed portions of the electric power lines that are adjacent are arranged offset from each other in a direction in which the electric power lines extend.

5. The power unit according to claim 4, wherein the removed portions of the electric power lines that are adjacent are arranged so as not to overlap with each other in the direction in which the electric power lines extend.
